(19) United States
(12) Patent Application Publication
(10) Pub. No.: US 2022/0219470 A1
(43) Pub. Date: Jul. 14, 2022

(54) LIGHTING ASSEMBLIES WITH REFLECTIVE SURFACES

(71) Applicant: Hewlett-Packard Development Company, L.P., Spring, TX (US)

(72) Inventors: Saurabh Shripad Bhide, Vancouver, WA (US); Daniel Ethan Frantz Quarto, Vancouver, WA (US); Rachelle Heather Castilloux Cobb, Vancouver, WA (US)

(73) Assignee: Hewlett-Packard Development Company, L.P., Spring, TX (US)

(21) Appl. No.: 17/613,981

(22) PCT Filed: Sep. 19, 2019
(86) PCT No.: PCT/US2019/051855

§ 371 Date: Nov. 24, 2021

(51) Int. Cl. B41J 29/19; B41J 3/36; F21V 33/00; F21V 7/06

(52) U.S. Cl. CPC B41J 29/19; F21V 7/06; F21V 33/0048; B41J 3/36

(57) ABSTRACT

In one example in accordance with the present disclosure, a lighting assembly for a handheld printing system is described. The lighting assembly includes a light source to emit a beam of light onto a surface to generate a light box which indicates a print area on the surface to receive printed content as the handheld printing system is moved. The lighting assembly also includes a reflective surface to reflect the beam of light towards a molded opening and the molded opening through which the beam of light passes. The lighting assembly also includes a clear cover over the molded opening.

### BACKGROUND

Printing is the operation of forming images, text, and/or any other characters or patterns on print media. The print compound used to form the patterns on the print media may be wet or dry. For example, wet print compound may be referred to as ink and dry print compound may be referred to as toner. Printing devices come in a variety of forms. For example, a printing device may be a laser printer or an inkjet printer.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a lighting assembly with a reflective surface, according to an example of the principles described herein.

FIG. 2 is a cross-sectional side view of a handheld printing system with a lighting assembly with a reflective surface, according to an example of the principles described herein.

FIG. 3 is a top view of a handheld printing system with a lighting assembly with a reflective surface, according to an example of the principles described herein.

FIG. 4 is a flow chart of a method for handheld printing, according to an example of the principles described herein.

FIG. 5 is a flow chart of a method for handheld printing, according to another example of the principles described herein.

FIG. 6 is an isometric view of a front surface of a handheld printing system with a lighting assembly with a reflective surface, according to an example of the principles described herein.

FIG. 7 is an isometric view of a front surface of a handheld printing system with a lighting assembly with a reflective surface, according to another example of the principles described herein.

FIG. 8 is a cross-sectional top view of a lighting assembly with a reflective surface, according to an example of the principles described herein.

FIG. 9 is a cross-sectional top view of a lighting assembly with a reflective surface, according to another example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Printing refers to a process wherein images and/or text are formed on print media such as paper. A variety of printing methods exist, the different methods using different types of print compound. For example, the print compound may be a liquid. An inkjet printer may use liquid print compound, which may be referred to as ink. In this example, the inkjet printer includes a number of printheads which eject small droplets of the ink. In some examples, the printhead moves relative to the print media, in other examples the printhead is stationary. In either example, the small droplets form the image/characters on the print media.

Another example of a printer is a laser printer which uses dry compound, sometimes referred to as toner, to form the images/characters. In this example, an electrostatic template of the desired image/characters is formed on a rotating drum that has an electrical charge. A cartridge dispenses the toner, but just those portions of the drum that have a charge retain deposited toner. This toner is then transferred to the print media as it comes into contact with the drum.

In general, a printing device is stationary, while the print media is moved through the printing device. For example, sheets of print media may be loaded or fed into the printing devices, with the devices then advancing the media while depositing print compound onto the print media.

However, the present specification describes a moving printing device, which may be handheld in some examples. In this example, rather than the print media advancing through a stationary printing device, the printing device moves and the print medium remains stationary. In a particular example, a user manually moves a handheld portable printing device over the print medium and the printing device prints a swath of print content on the print medium as the user moves the handheld portable printing device. Doing so may allow for small images to be printed and increases the capability of image/text formation. For example, in some examples, it may be difficult to load certain media, such as envelopes and labels, into a stationary printing device. Accordingly, the portable printing device as described herein allows for more facile printing on media that is otherwise complex to print on. Such a portable printing device also allows for printing on surfaces that are unloadable into a stationary printing device, such as a cardboard box or for printing on permanent surface such as a wall, floor, or window.

Moreover, a moving printing device allows for printing at non-orthogonal angles. For example, using a stationary printing device, it may be difficult to print text at a non-orthogonal angle relative to the print medium. Such a portable printing device facilitates such printing. However, a user of a printing device may be unable to determine the exact location where the printing device will print on a print medium.

Accordingly, the present specification describes a lighting assembly, which may be integrated into or selectively removable from a handheld printing device, that addresses these issues. Specifically, the present specification describes a lighting system that projects a light box onto a print medium. The light box has top and bottom edges corresponding to the swath of print content that the printing device will print on the print medium as the device is moved across the print medium. The light box has a leading edge indicating where the printing device will begin printing the swath as the device is moved across the print medium. Accordingly, a user is able to see where the printing device will output a swath of print content on a print medium once printing is initiated. While the present specification describes a lighting assembly that is used in a portable handheld printing device, the lighting assembly may also be used with a larger, but moveable, printing system.

The light box also is used to alert a user as to a print direction as a user may not know which way to move the printer to print. The light box alleviates this condition by highlighting which direction the user should move, i.e., in the direction of the light box.

The light box also enables the user of a handheld printer to align the printer up with a ruler/or guide which helps the user to know how to align the guide with the start position. The guides purpose is to further help the user know the appropriate starting location and alignment of the print on the media, and the light box serves as the registration between the guide and the printing device as controlled by the user.

During use, the user may move the handheld printing device around the print medium until the printing device projects the light box at a desired printing location on the print medium. Once the user has positioned the handheld printing device on the print medium in this manner, the user may initiate the printing process and move the printing device across the print medium to cause the device to output print content at the desired printing location.

While such a light box is beneficial in providing visual indicia of where printed content is to be formed, an increased sharpness to the light box provides a more effective and accurate visual indication of print compound deposition. Accordingly, the present specification describes hardware for projecting a lightbox to determine a print direction, print placement, and/or print size of a print job, prior to initialization of the print job. Specifically, the hardware includes a light source such as a light emitting diode (LED), a reflective element such as a mirror/lens, an integrated opening, a ledge, a rib and a clear cover over the molded opening. Light emanating from the light source is reflected by the reflective element through the opening onto a media plane to form a lightbox that indicates direction and size of the print output.

In some examples, a ledge is placed below the light source to block the light from directly hitting the media plane through the opening without bouncing off the reflective element. In some cases, a rib is placed within the housing to block extremal light from entering the housing. In some examples, edges of the housing where the clear cover meets the housing of the lighting assembly are angled and/or curved inwardly to reflect the light internally and/or textured so as to avoid ghosting effects on the media. Accordingly, the present specification describes a lighting assembly that assists in determining print direction, placement and size of the print output while preventing unwanted access and extremal contaminants from entering the printer components.

Accordingly, the present specification describes a lighting assembly for a printing system, which printing system may be moveable, either automatically or under an applied force, and in some examples handheld. The lighting assembly includes a light source to emit a beam of light onto a surface to generate a light box which indicates a print area on the surface to receive printed content as the printing system is moved. A reflective surface of the lighting assembly reflects the beam of light towards a molded opening. The lighting assembly also includes the molded opening through which the beam of light passes and a clear cover over the molded opening.

The present specification also describes a handheld printing system. The handheld printing system includes a printing device to form printed content onto a surface as the handheld printing system is moved. The handheld printing system also includes a lighting assembly. The lighting assembly includes a housing, a light source on a first wall of the housing to emit a beam of light to generate a light box which indicates a print area on the surface to receive printed content as the handheld printing system is moved. At least one reflective surface is on a second, and opposite, wall of the housing to reflect the beam of light towards a molded opening. The lighting assembly also includes a molded opening on the first wall through which the beam of light passes. A clear cover is disposed over the molded opening.

The present specification also describes a method. According to the method, a beam of light is emitted from a light source towards a reflective surface. The beam of light is reflected off the reflective surface towards a molded opening. The light is filtered to define a light box that identifies a print area and a print direction on a surface that is to receive printed content. A leading edge of the light box indicates where printing of the printed content is to start.

Such systems and methods 1) allow for portable printing on a print medium; 2) increase flexibility of the surfaces and placement of print compound on a print medium; and 3) provide a visual indication of where printed symbols are to be located on a print medium.

As used in the present specification the term “print compound” refers to a compound that is deposited on a media, such as a sheet of paper, to form the images, text, or other patterns. Print compound may be wet. For example, the print compound may be ink. Print compound may be dry. For example, the print compound may be toner.

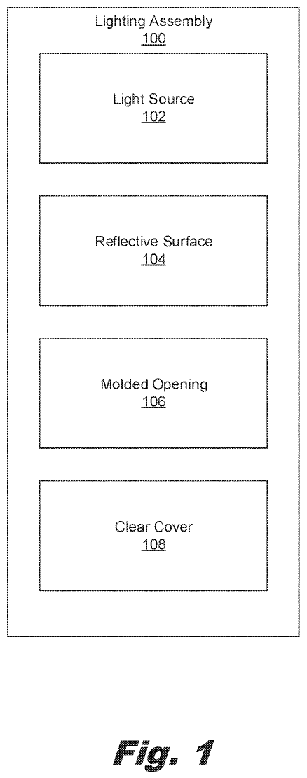

Turning now to the figures, FIG. 1 is a block diagram of a lighting assembly (100) with a reflective surface (104), according to an example of the principles described herein. As described above, the lighting assembly (100) may be a component of a handheld printing system or other moveable printing system. The lighting assembly (100) may be modular relative to the handheld printing system. That is, the lighting assembly (100) may be removable from a housing of the handheld printing system. For example, the lighting assembly (100) may snap into place or be held into place via fasteners such as screws or tabs and hooks. In another example, the lighting assembly (100) is integrated into the housing of the handheld printing system.

The lighting assembly (100) includes a light source (102) that emits a beam of light onto a surface to generate a light box, which light box as described above corresponds to a location on a print medium where images, text, symbols, and/or characters may be deposited. That is, the light box indicates a print area on a surface that is to receive printed content as the handheld printing system is moved. The light source (102) may take many forms. For example, the light source may be a light emitting diode (LED), a laser, a tungsten bulb or any other hardware component that emits light.

The lighting assembly (100) also includes a reflective surface (104) to reflect the beam of light towards a molded opening (106). That is, in the example depicted herein, the beam of light does not directly exit the molded opening (106), but is reflected off the reflective surface (104). Doing so increases the distance between the source of the light and the surface that it is ultimately projected on to. Doing so sharpens the edges of the light box. The more clearly defined light box presents a more accurate and reliable indication of print compound placement. The reflected light exits the lighting assembly (100) through a molded opening (106) that is covered by a clear cover (108). As will be described below, either the molded opening (106) or the clear cover (108) have a shape that allows light to pass and that define the light box shape. That is, the molded opening (106) or clear cover (108) may have a trapezoidal shape that defines a rectangular light box that is projected onto the print medium.

Thus, the described lighting assembly (100) presents a visual indication to a user as to a region on the print medium where printed content is to be formed such that a user may selectively place the associated printing system at a location such that the desired printed content is formed in a desired location. Put another way, the lighting assembly (100) facilitates increased flexibility and accuracy relating to the formation of printed content onto a variety of printed surfaces in a variety of directions.

The clear cover (108) also prevents contaminants from entering the lighting assembly (100) and the overall handheld printing system in which it is placed. That is, particulate matter such as dust may impede the operation of components of the handheld printing system including the actual print device. Accordingly, the clear cover (108) allows for light to exit the above-mentioned light box all while preventing contamination of internal components of the handheld printing system.

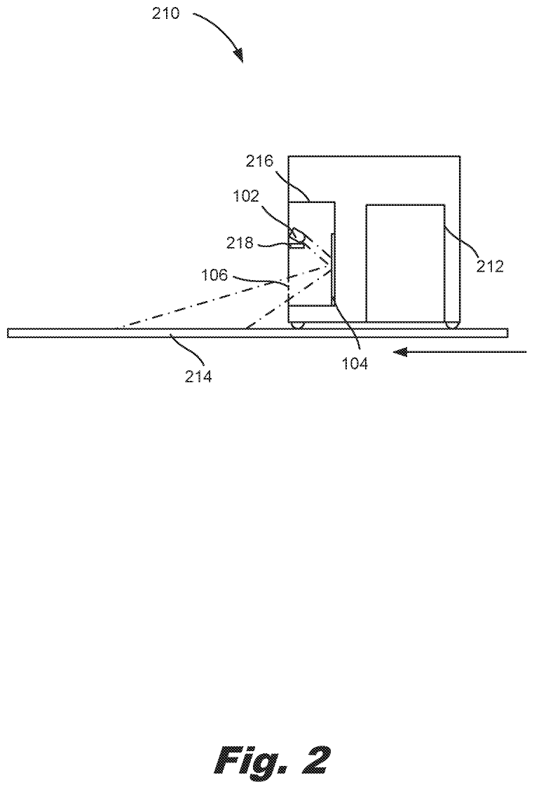

FIG. 2 is a cross-sectional side view of a handheld printing system (210) with a lighting assembly (FIG. 1, 100) with a reflective surface (104), according to an example of the principles described herein.

The handheld printing system (210) includes a housing that is grasped by a user and moved across a print medium (214) surface, as indicated by the arrow. For example, the handheld printing system (210) may include wheels or casters that roll over the surface of the print medium (214). As used in the present specification and in the appended claims, the term “print medium” is meant to be understood broadly as any surface onto which a fluid ejected from a nozzle of a printing device (212) may be deposited. In one example, the print medium (214) may be paper; however other print mediums (214) may similarly be printed on.

The handheld printing system (210) includes a printing device (212) to form printed content onto a surface as the handheld printing system (210) is moved. As used in the present specification and in the appended claims, the term “printing device” may refer to a device used in the ejection of ink, or other fluid, onto a print medium. In general, a printing device may be a fluidic ejection device that dispenses fluid such as ink, wax, polymers or other fluids. A printer cartridge may include a printhead.

The printing device (212) includes an interface with a computing device. In general, the computing device may be any source from which the printing device (212) may receive data describing a print job to be executed by the controller of the printing device (212) in order print an image onto the print medium (214). For example, via the interface, the controller of the printing device (212) receives data from the computing device and temporarily stores the data in the data storage device of the printing device (212). Data may be sent to the printing device (212) along an electronic, infrared, optical, or other information transfer path. The data may represent a document and/or file to be printed. As such, data forms a print job for the printing device (212) and includes print job commands and/or command parameters.

The controller of the printing device (212) also controls the printhead in ejecting fluid from the nozzles of the printing device (212). For example, the controller defines a pattern of ejected fluid drops that form characters, symbols, and/or other graphics or images on the print medium (214). The pattern of ejected fluid drops is determined by the print job commands and/or command parameters received from the computing device. The processor of the printing device (212) may include the hardware architecture to retrieve executable code from the data storage device and execute the executable code. The executable code may, when executed by the processor, cause the processor to implement at least the functionality of printing on the print medium.

The printing device (212) also includes a data storage device to store data such as executable program code that is executed by the processor or other processing device. The data storage device may specifically store computer code representing a number of applications that the processor executes to implement at least the functionality described herein.

The data storage device may include various types of memory modules, including volatile and nonvolatile memory. For example, the data storage device of the present example includes Random Access Memory (RAM), and Read Only Memory (ROM). Many other types of memory may also be utilized, and the present specification contemplates the use of many varying type(s) of memory in the data storage device as may suit a particular application of the principles described herein.

Generally, the data storage device may include a computer readable medium, a computer readable storage medium, or a non-transitory computer readable medium, among others. For example, the data storage device may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device.

To eject fluid, the printing device (212) includes a printhead and a reservoir. The printhead may include a number of components for depositing a fluid onto a print medium (214). For example, the printhead may include a number of nozzles. A nozzle may include an ejector, a firing chamber, and an opening. The opening may allow fluid, such as ink, to be deposited onto a surface, such as a print medium (214). The firing chamber may include a small amount of fluid. The ejector may be a mechanism for ejecting fluid through the opening from the firing chamber, where the ejector may include a firing resistor or other thermal device, a piezoelectric element, or other mechanism for ejecting fluid from the firing chamber.

For example, the ejector may be a firing resistor. The firing resistor heats up in response to an applied voltage. As the firing resistor heats up, a portion of the fluid in the firing chamber vaporizes to form a bubble. This bubble pushes liquid fluid out the opening and onto the print medium (214). As the vaporized fluid bubble pops, a vacuum pressure within the firing chamber draws fluid into the firing chamber from the fluid supply, and the process repeats. In this example, the printhead may be a thermal inkjet printhead.

In another example, the ejector may be a piezoelectric device. As a voltage is applied, the piezoelectric device changes shape which generates a pressure pulse in the firing chamber that pushes a fluid out the opening and onto the print medium (214). In this example, the printhead may be a piezoelectric inkjet printhead.

Nozzles may be arranged in columns or arrays such that properly sequenced ejection of fluid from the nozzles causes characters, symbols, and/or other graphics or images to be printed on the print medium (214) as the printing device (212) moves over the print medium (214).

As described above, the printing device (212) also includes a fluid reservoir to supply an amount of fluid to the printhead. The print medium (214) on to which the print compound is deposited may be any type of suitable sheet or roll material, such as paper, card stock, transparencies, polyester, plywood, form board, fabric, canvas, and the like.

The handheld printing system (210) also includes a lighting assembly (FIG. 1, 100) to, as described above, project a light box onto the print medium (214). The lighting assembly (FIG. 1, 100) includes a housing (216). Disposed in the housing (216) is a light source (102) that, as described above, emits a beam of light to generate a light box which indicates the print area on the surface of the print medium (214) to receive printed content as the handheld printing system (210) is moved. That is, the light source (102) defines a top, bottom, and leading edge of a print area. It does not however, indicate an exact size of print content nor a defined trailing edge of the print area. As described above, the light source (102) may take many forms including light-emitting elements, such as light-emitting diodes (LEDs). The lighting assembly (FIG. 1, 100) also includes a reflective surface (104) and a molded opening (106) with a clear cover (FIG. 1, 108) disposed thereon.

As depicted in FIG. 2, in some examples, the light source (102) and the molded opening (106) are on a first wall of the housing (216) and the at least one reflective surface (104) is located on a second and opposite wall of the housing. Bouncing the light that forms the light box off the reflective surface (104) increases the distance between the light source (102) and the surface onto which the light box is projected, which enhances the clarity of the light box. That is, to get sharp edges on a projected lightbox, a distance between the light source (102) and the print medium (214) should be greater than the distance from the molded opening (106) to the projected surface, i.e., the print medium (214). The greater the difference between the two, the sharper the projected light box. The reflective surface (104), which may be a planar or cylindrical mirror, is used to increase the distance between the light source (102) and the print medium (214) all within a small handheld portable printing system (210) thereby increasing the sharpness of the light box edges. While FIG. 2 depicts a single reflective surface (104), the lighting assembly (FIG. 1, 100) may include multiple reflective surfaces (104), placed relative to each other, to further increase this distance.

As will be described in particular examples depicted below, the molded opening (106) may have particular dimensions based on the relative position of the reflective surface (104) and light source (102), to produce an image of given width.

As described above, the housing (216) also has an integrated clear cover (FIG. 1, 108) over the molded opening (106) to isolate the components from external contamination, unintended customer access, and any electrostatic discharge (ESD) events. The housing (216) is directly datumed to the carriage/chassis which in turn also serves as the datum to the printhead assembly.

In some examples, the handheld printing system (210) may include other components. For example, the lighting assembly (FIG. 1, 100) may include a ledge (218) below the light source (102) to prevent incident light exiting the molded opening (106). That is, in order to produce a sharp and crisp light box, incident light may be controlled. Accordingly, the present lighting assembly (FIG. 1, 100) includes a ledge (218) or hood just underneath the light source (102) to block the light from directly hitting the print medium (214) through the molded opening (106) without first bouncing off the reflective surface (104). Accordingly, the leading edge of the light box projected onto the print media (214) provides an unambiguous indication as to where the printed elements will begin.

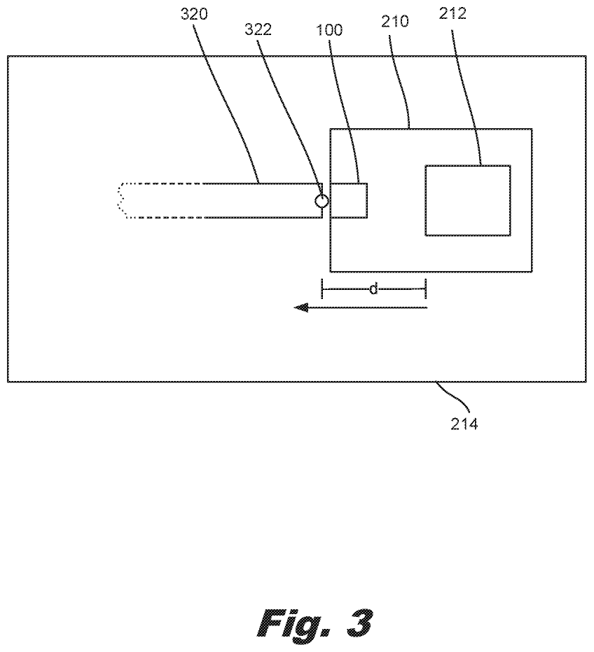

FIG. 3 is a top view of a handheld printing system (210) with a lighting assembly (100) with a reflective surface (FIG. 1, 104), according to an example of the principles described herein. As described above, the lighting assembly (100) projects light that forms a light box (320). Prior to printing, the light box (320) indicates the location on the print medium (214) at which the printing device (212) will print a swath of printed content once printing is initiated. The printing system (210) is then moved, such as by a user, across the print medium (214) in the direction denoted by the arrow.

The light box (320) has a top edge and a bottom edge. These edges are parallel to one another and correspond to the swath of print content that the printing device (212) will print on the print medium (214) when printing is initiated and the handheld printing system (210) is moved across the print medium (214). That is, the distance between the edges of the light box (320) is equal to the width of the print content swath that the printing device (212) will print.

The light box (320) also has a leading edge, being that edge closest to the handheld printing system (210). The leading edge is perpendicular to the top and bottom edges. The leading edge indicates where the printing device (212) will begin printing a swath of content on the print medium (214) when printing is initiated and the printing device (212) is moved. In other words, as the printing device (212) is moved, the controller may prevent printing until the nozzles are lined up with the leading edge of the light box (320) as it is projected when the handheld printing system (210) is stationary.

That is, during use the leading edge of the light box (320) may move as the lighting assembly (100) moves. However, prior to such movement, while the user is establishing a desired print position, the leading edge of the light box (320) is disposed at a registration location (322) on the print medium (214). The registration location (322) is a distance, d, away from the printing device (212). When a user initiates printing, for example by depressing a button, or moving the handheld printing system (210), printing is not initiated until the printing device (212) is over this registration location (322), that is until the printing device (212) has covered the distance, d.

To effectuate this delayed printing, the controller of the printing device (212) may include a mapping between the distance, d, and a speed of movement of the handheld printing system (210) such that printing is initiated just as the printing device (212) passes over the registration location (322), i.e., the printing device has traveled the distance, d.

After printing has initiated, the leading edge of the light box (320) may no longer indicate where printing is to begin as printing has already begun. However, the light box (320) still provides a visual indication as to where printing is to occur, such that a user may rely on the light box (320) as a guide for straight printing or printing along a particular path.

On account of the increased distance between the light source (FIG. 1, 102) and the surface of the print medium (214) on account of the reflective surface (FIG. 1, 104), the leading edge can be sharp, providing a clear visible delineation of where printing will begin. In other words, the lighting assembly (100) reflects light off of a reflective surface (FIG. 1, 104) and projects out of the molded opening (FIG. 1, 106) to form a three-sided lightbox (320) on the print medium (214) with a clear sharp leading edge that indicates where printing will begin.

As the handheld printing system (210) is moved across the print medium (214), a printhead, such as an inkjet printhead can eject a swath of ink onto the print medium (214). The swath of ink may have a width corresponding to the printhead width. While particular reference is made to a printing device (212) that implement inkjet printing, the printing device (212) may use a printing technology other than inkjet.

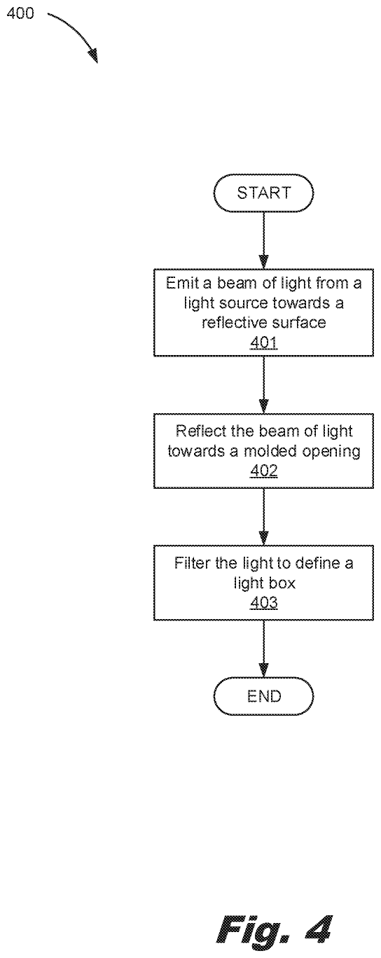

FIG. 4 is a flow chart of a method (400) for printing, according to an example of the principles described herein. Prior to printing, the printing system, which may be a handheld printing system (FIG. 2, 210), is placed onto a print medium (FIG. 2, 214). A light box (FIG. 3, 320) is then projected onto the surface of the print medium (FIG. 2, 214). Specifically, a beam of light is emitted (block 401) from a light source (FIG. 1, 102) towards a reflective surface (FIG. 1, 104). The beam of light, which may originate from any variety of light sources (FIG. 1, 102) including any number of LEDs or a laser, is reflected (block 402) off a reflective surface (FIG. 1, 104) towards a molded opening (FIG. 1, 106). At the molded opening (FIG. 1, 106) the light is filtered (block 403) to define a light box (FIG. 3, 320) that identifies a print area and a print direction on a surface that is to receive printed content. That is, the light box (FIG. 3, 320) has top and bottom edges corresponding to the print area and indicates where the printing device (FIG. 2, 212) will print the swath. Specifically, a leading edge of the light box (FIG. 3, 320) in an initial stationary position indicates a registration location (FIG. 3, 322) where printing of the printed content is to start.

As a particular example, a user may place the handheld printing system (FIG. 2, 210) on the print medium (FIG. 2, 214). The user may then press a button or other control on the printing system (FIG. 2, 210) to cause the lighting assembly (FIG. 1, 100) to project a light box (FIG. 3, 320). The user may then reposition the handheld printing system (FIG. 2, 210) as desired on the print medium (FIG. 2, 214) until the light box (FIG. 3, 320) is projected at the location on the print medium (FIG. 2, 214) at which the user wants printed content to be formed. The handheld printing system (FIG. 2, 210) may continue displaying the light box (FIG. 3, 320) until the user subsequently initiates printing and potentially longer.

Once the user has positioned the handheld printing system (FIG. 2, 210) at a desired location on the print medium (FIG. 2, 214), i.e., where the light box (FIG. 3, 320) is projected at the desired location on the print medium (FIG. 2, 214), the user may press a button or other control on the printing system (FIG. 2, 210) to start the printing process. Upon so doing, the printing device (FIG. 2, 212) may, based on the speed of movement, pause printing until the registration location (FIG. 3, 322) is reached by the nozzle array of the printhead of the printing device (FIG. 2, 212).

The printing device (FIG. 2, 212) then prints the printed content on the print medium (FIG. 2, 214) as the user moves the handheld printing system (FIG. 2, 210) across the print medium (FIG. 2, 214), starting at the location at which the light box (FIG. 3, 320) was at the time the user signaled to the printing system (FIG. 2, 212) to initiate the printing process.

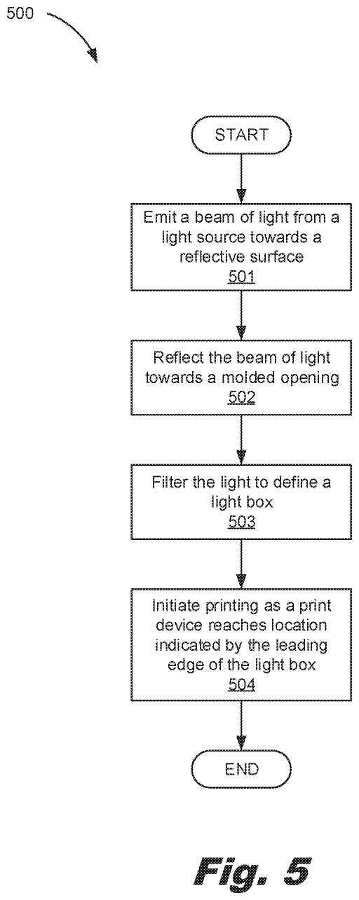

FIG. 5 is a flow chart of a method (500) for printing, according to another example of the principles described herein. According to the method (500), a beam of light is emitted (block 501) from a light source (FIG. 1, 102), reflected (block 502) off a reflective surface (FIG. 1, 104) towards a molded opening (FIG. 1, 106) where it is filtered (block 503) to generate the light box (FIG. 3, 320). All this may be done as described above in connection with FIG. 4.

In this example, printing is then initiated (block 504) as a printing device (FIG. 2, 212) reaches a location indicated by the leading edge of the light box (FIG. 3, 320) as a handheld printing system (FIG. 2, 210) is moved. That is, the handheld printing system (FIG. 2, 210) is calibrated such that a registration location (FIG. 3, 322) of a leading edge of a light box (FIG. 3, 320), which registration location (FIG. 3, 322) indicates a location of the leading edge on the print medium (FIG. 2, 214) prior to initialization of printing, is used as a reference point for beginning printing. That is, based on a distance, d, between the registration location (FIG. 3, 322) and the printing device (FIG. 2, 212) and a speed of movement, the controller of the printing device (FIG. 2, 212) may initiate printing when the printing device (FIG. 2, 212) has moved the same distance, d.

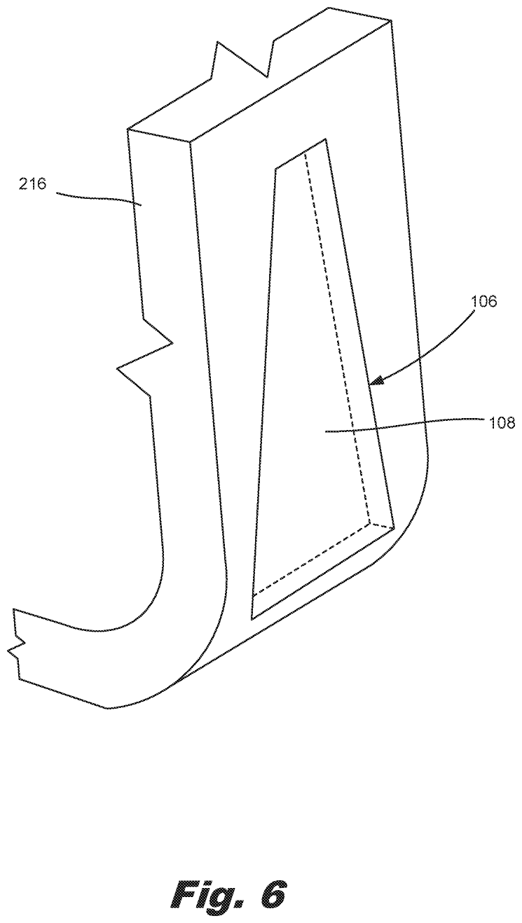

FIG. 6 is an isometric view of a front surface of a handheld printing system (FIG. 2, 210) with a lighting assembly (FIG. 1, 100) with a reflective surface (FIG. 1, 104), according to an example of the principles described herein. As described above, the light box (FIG. 3, 320) may be rectangular in shape. To facilitate this rectangular light box (FIG. 3, 320), the light is filtered to be trapezoidal in shape. Accordingly, either the molded opening (106) itself or the clear cover (108) may be trapezoidal in shape. The long sidewalls of the trapezoid taper from the bottom edge towards the top edge, where the bottom edge is longer than the top edge. The sidewalls of the trapezoid correspond to the top and bottom of the light box (FIG. 3, 320) as depicted in FIG. 3.

Put another way, the edges of the trapezoid taper towards one another so that projection of the light by the light source (FIG. 1, 102) results in a rectangular light box (FIG. 3, 320). That is, while the edges of the light box (FIG. 3, 320) are parallel to one another in FIG. 3, the edges of the trapezoid are not parallel to one another. The bottom edge of the trapezoid corresponds to the leading edge 116 of the light box (FIG. 3, 320), the top edge of the trapezoid (FIG. 3, 320) corresponds to the fading trailing edge of the light box (FIG. 3, 320), and the side walls of the trapezoid correspond to the top and bottom edges of the print swaths. The light box (FIG. 3, 320) that has been described permits a user to assess where the handheld printing system (FIG. 2, 210) will print the printed content on the print medium (FIG. 2, 214) and where printing will start (i.e., at the registration location (FIG. 3, 322).

As described above, in some examples, the molded opening (106) may define the edges of the light box (FIG. 3, 320). That is, the molded opening (106) itself may be in the trapezoid shape described above. In this example, the clear cover (108) may be formed of a clear plastic that is co-molded with the housing (216) of the lighting assembly (FIG. 1, 100). That is, both the clear cover (108) and the housing (216) may be molded, albeit of different materials. Co-molding allows the exterior surface to be flush with the rest of the handheld printing system (FIG. 2, 210) without having airgaps around the perimeter of the molded opening (106), which could present optical issues and may allow for introduction of external contaminants. In one particular example, the clear cover (108) may be as thin as the molding process would allow in order to minimize refraction-related optical artifacts. In some examples, the inside surfaces of the co-molded clear cover (108) may be designed, in accordance with the law of refraction to reduce hotspots and make uniform rectangular light.

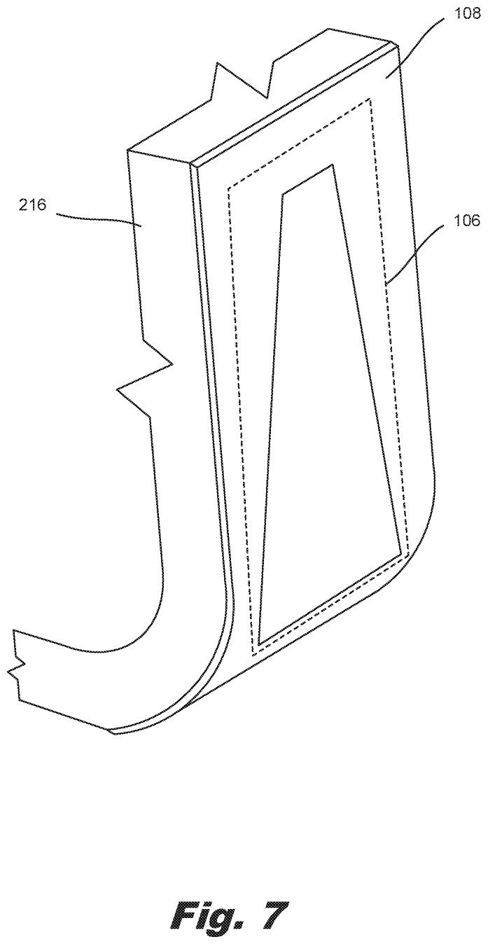

FIG. 7 is an isometric view of a front surface of a handheld printing system (FIG. 2, 210) with a lighting assembly (FIG. 1, 100) with a reflective surface (FIG. 1, 104), according to another example of the principles described herein. In this example, the clear cover (108) has a printed aperture that defines the shape of the light box (FIG. 3, 320). That is, a molded opening (106) in the housing of the lighting assembly (FIG. 1, 100) may be a generic shape and so long as it is larger than the clear cover (108) printed aperture, it does not influence light output. In FIG. 7, the molded opening is depicted in ghost to indicate its position behind the clear cover (108) printed aperture. In this example, the clear cover (108) defines the edges of the light box (FIG. 3, 320) and may be a thin film placed over the molded opening (106).

Portions of the clear cover (108) may be blacked out. For example, that portion that represents a negative image of the trapezoid may be printed using a black polycarbonate while the portion defining the trapezoid may be printed using a clear polycarbonate. Using such a thin film clear cover (108) provides for a cover that is thinner than a molded part, which reduces optical artifacts arising from thick lens refraction.

Moreover, the shape of the light box (FIG. 3, 320) could be modified by changing that region of the thin film that is clear and that which is black. Thus, the light box (FIG. 3, 320) shape could be adjusted/customized for various purposes. Moreover, using a thin film attached to the housing (216) allows for the use of specialized film materials to create mirror finish/dead front style facades, in some cases hiding the internals of the lighting assembly (FIG. 1, 100) when the light source (FIG. 1, 102) is off. In another example, additional detailing could be printed around the trapezoid on the thin film layer.

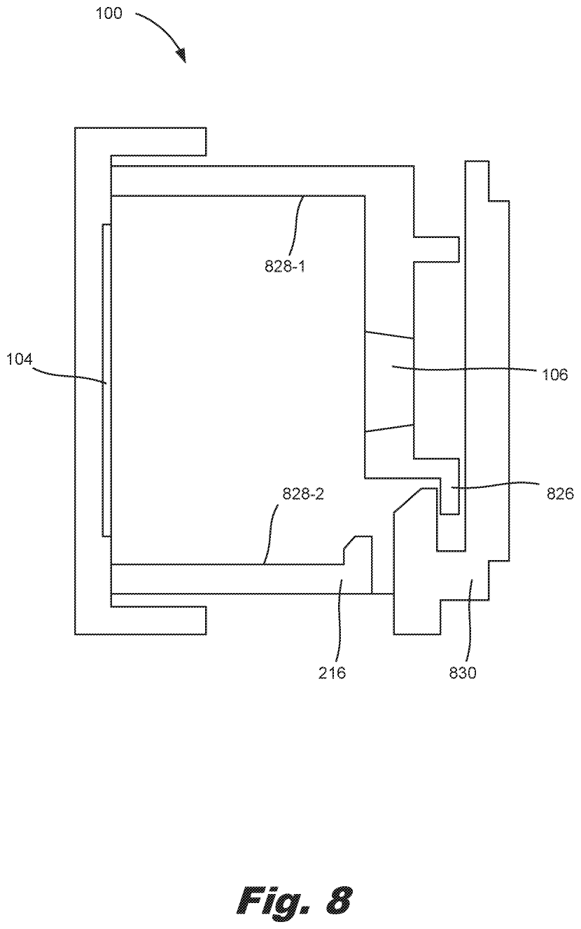

FIG. 8 is a cross-sectional top view of a lighting assembly (100) with a reflective surface (104), according to an example of the principles described herein. FIG. 8 clearly depicts the molded opening (106) on one wall and the reflective surface (104) on the opposite wall of the housing (216). Note that as depicted in at least FIG. 2, a set in which the light source (FIG. 1, 102) sits is disposed on a same wall as the molded opening (106). Light within the lighting assembly (FIG. 1, 100) may be managed to ensure the resulting light box (FIG. 3, 320) is sharp, crisp, and clean. Accordingly, interior surfaces of the housing (216) may be angled to reduce reflection of the beam of light. In some examples, the housing (216) is designed to control where reflected light is directed. Accordingly, the surfaces where the clear cover (FIG. 1, 108) meet the opaque body, may be angled or even curved to reflect light internally to the assembly to reduce ghosting on the output light box (FIG. 3, 320). Still further, in some examples, different walls (828-1, 828-2) of the housing (216) may have a surface treatment to reduce reflection of the beam of light.

As yet another example, the housing (216) may include ribs (826) to affix the lighting assembly (FIG. 1, 100) in a handheld printing system (FIG. 2, 210). That is, the lighting assembly (FIG. 1, 100) may “snap” into a housing (830) of the handheld printing system (FIG. 2, 210). In this example, nesting of components reduces light leakage through the part, all without using any compliant/gasket materials. That is, these joining ribs (826) block external light from entering the lighting assembly (FIG. 1, 100).

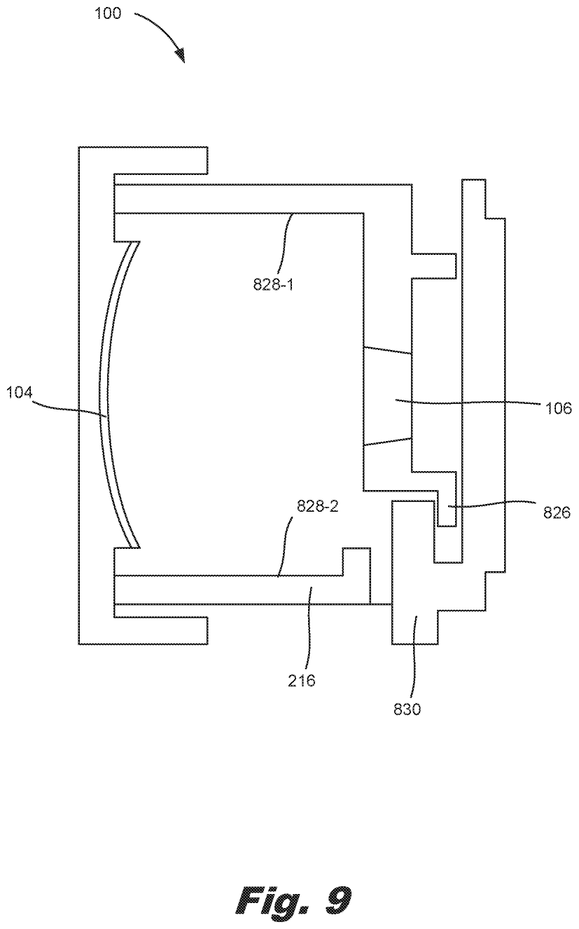

FIG. 9 is a cross-sectional top view of a lighting assembly (100) with a reflective surface (104), according to another example of the principles described herein. In some examples, the lighting assembly (100) may include a flat reflective surface (104) as depicted in FIG. 8. However, in other examples, the reflective surface (104) may be concave. A concave reflective surface (104) may collimate the light from the light source (FIG. 1, 102) while increasing the brightness of the projected light box (FIG. 3, 320). Specifically, a concave reflecting surface (104) may have a focal length 2x the distance between the light source (FIG. 1, 102) and the reflective surface (104).

Such systems and methods 1) allow for portable printing on a print medium; 2) increase flexibility of the surfaces and placement of print compound on a print medium; and 3) provide a visual indication of where printed symbols are to be located on a print medium.

What is claimed is:

1. A lighting assembly for a printing system, comprising:
a light source to emit a beam of light onto a surface to generate a light box which indicates a print area on the surface to receive printed content as the printing system is moved;
a reflective surface to reflect the beam of light towards a molded opening:
the molded opening through which the beam of light passes; and
a clear cover over the molded opening.

2. The lighting assembly of claim 1, wherein the light source is disposed on a same wall of a housing as the molded opening through which the beam of light passes.

3. The lighting assembly of claim 1, wherein the molded opening defines edges of the light box.

4. The lighting assembly of claim 1, wherein the clear cover defines edges of the light box.

5. The lighting assembly of claim 1, wherein the clear cover is a thin film placed over the molded opening.

6. The lighting assembly of claim 1, wherein the clear cover is formed of clear plastic that is co-molded with a housing of the lighting assembly.

7. The lighting assembly of claim 1, wherein the reflective surface is concave.

8. The lighting assembly of claim 1, further comprising a ledge below the light source to prevent incident light exiting the molded opening.

9. The lighting assembly of claim 1, further comprising ribs to:
affix the lighting assembly in the printing system; and
block external light from entering the lighting assembly.

10. A handheld printing system, comprising:
a printing device to form printed content on a surface as the handheld printing system is moved;
a lighting assembly comprising:
a housing;
a light source on a first wall of the housing to emit a beam of light to generate a light box which indicates a print area on the surface to receive printed content as the handheld printing system is moved;
at least one reflective surface on a second and opposite wall of the housing to reflect the beam of light towards a molded opening;
the molded opening on the first wall through which the beam of light passes; and
a clear cover over the molded opening.

11. The handheld printing system of claim 10, wherein at least one wall of the housing has a surface treatment to reduce reflection of the beam of light.

12. The handheld printing system of claim 10, wherein the at least one reflective surface comprises a plurality of reflective surfaces.

13. The handheld printing system of claim 10, wherein the housing comprises angled surfaces to reduce reflection of the beam of light.

14. A method, comprising:
emitting a beam of light from a light source towards a reflective surface;
reflecting the beam of light off a reflective surface towards a molded opening; and
filtering the beam of light to define a light box that identifies a print area and a print direction on a surface that is to receive printed content, wherein a leading edge of the light box indicates where printing of the printed content is to start.

15. The method of claim 14, further comprising initiating printing as a printing device reaches a registration location indicated by the leading edge of the light box as a printing system is moved.
